(19) United States
(12) Patent Application Publication
(10) Pub. No.: US 2026/0284739 A1
(43) Pub. Date: Sep. 24, 2026

(54) APPARATUS AND METHOD FOR REFINING LIQUID METAL

(71) Applicant: Danieli & C. Officine Meccaniche S.P.A., Buttrio (UD) (IT)

(72) Inventors: Federico BIANCO, Buttrio (UD) (IT); Johnny MANTOANI, Buttrio (UD) (IT); Marco ANSOLDI, Buttrio (UD) (IT); Massimo VARUTTI, Buttrio (UD) (IT)

(21) Appl. No.: 19/476,667

(22) PCT Filed: Mar. 27, 2024
(86) PCT No.: PCT/IT2024/050064

§ 371 Date: Oct. 17, 2025

(30) Foreign Application Priority Data
Apr. 18, 2023 (IT) 102023000007446

(51) Int. Cl. B22D 11/117; B22D 11/113; B22D 46/00; C21C 7/00; C21C 7/072; C21C 7/10; C22B 9/04; C22B 9/05; F27D 21/02

(52) U.S. Cl. CPC B22D 11/117; B22D 11/113; B22D 46/00; C21C 7/0075; C21C 7/072; C21C 7/10; C22B 9/04; C22B 9/05; F27D 21/02; C21C 2250/08

(57) ABSTRACT

Apparatus (10) for refining liquid metal (L) comprising: a ladle (11) containing the liquid metal (L) provided with an open upper part (12) and with at least one porous plug (13) on a bottom wall (14) thereof, a removable lid (19, 23), a gas injection line (21) connected to said at least one porous plug (13), and a control unit (27).

### FIELD OF THE INVENTION

The present invention concerns an apparatus and method for refining liquid metal in the context of steel secondary metallurgy processes which occur in a ladle, downstream of the electric arc furnace (EAF) and before continuous casting. The refining apparatus and method are aimed in particular at controlling the injection of inert gas into the liquid metal to determine a desired stirring in order to facilitate the removal of inclusions and impurities while alloying elements are possibly inserted to obtain the desired chemical composition.

### BACKGROUND OF THE INVENTION

In the field of secondary metallurgy processes, especially for the production of so-called special-purpose steels, it is known to perform refining treatments directly in the ladle.

In particular, the treatments are carried out in a ladle furnace equipped with a lid through which electrodes are lowered in order to heat the liquid metal bath, and possibly, in a following step, also in a vacuum degasser that comprises a chamber which can be hermetically insulated with a lid, and inside which the ladle is positioned before the vacuum is generated inside it.

Refining treatments often include deoxidation, alloying, desulphurization, vacuum degassing and removal of inclusions, and they require a good degree of homogenization of the liquid metal, both in terms of chemical composition and also temperature.

Homogenization is ensured by a continuous stirring which is usually carried out with the injection of inert gas, for example argon or nitrogen, by means of submerged lances or porous plugs located on the bottom of the ladle and connected to a gas injection line, with the aim of continuously stirring the liquid metal bath and bringing up to the surface the solid and/or gaseous inclusions and impurities present therein.

Good stirring control is essential to maximize productivity and the quality of the metal. Unfortunately, the definition of the optimal gas flow rate is very difficult both because it depends on the specific secondary treatment in place, and also because malfunctions of the injection system often occur, for example obstructions of the porous plugs or the gas injection line.

The efficiency of the stirring depends on many parameters, for example the cleaning of the porous plugs between the ladle's cycles, the duration of the porous plugs and the duration of the refractory. Although most gas injection lines are instrumented with independent pressure sensors and flow meters, the readings are not sufficiently indicative of the actual state of stirring of the liquid metal in the ladle.

The particularly aggressive and smoke-rich environment, the high temperatures and the impossibility of a visual and direct inspection of the process, especially in the case of the vacuum degasser, have led technicians in the field to use systems to indirectly measure the state of stirring of the liquid metal, for example systems for measuring the mechanical vibrations of the ladle or the acoustic emission from turbulent stirring, or systems for detecting images with optical or infrared telecameras.

The most promising solution is currently the one that provides to use a telecamera mounted on the lid located above the ladle, which detects images of the free surface of the liquid metal bath.

However, especially in the vacuum degasser, in which the process occurs at a pressure lower than atmospheric pressure, the bubbling action generated by the injection of the gas causes a marked rise in the surface level of the liquid metal, which is typically formed by a layer of slag and sometimes foam, even making it overflow, flooding the containing chamber.

This bubbling produces a high formation of fumes and splashes of slag and liquid metal at temperatures that can reach up to about 1700 °C, which affect the structure and the very functionality of the telecamera, impeding a correct and prolonged image detection.

The analysis that is carried out on the images can therefore be scarcely used to guide the process because it is unreliable, and merely indicative of what is happening during the process.

There is therefore the need to perfect an apparatus and method for refining liquid metal that can overcome at least one of the disadvantages of the state of the art.

To do this, it is necessary to solve the technical problem of precisely and uniformly controlling the state of stirring and homogenization of the liquid metal throughout the entire refining process, both during the treatments that occur in the ladle furnace, but above all during the treatments that occur in the vacuum degasser which, since it is completely insulated from the outside, does not allow to visually inspect what happens inside it.

In particular, one purpose of the present invention is to provide an apparatus and perfect a method for refining liquid metal which allows to monitor the state of stirring of the liquid metal, essentially continuously or at pre-established time intervals, regardless of the highly aggressive environment (more or less intense vacuum, high temperatures, presence of smoke, splashes of liquid metal, etc.) present inside the apparatus.

Another purpose of the present invention is to provide an apparatus for refining liquid metal in which monitoring the stirring of the liquid metal yields information on the operating conditions of the porous plugs of the ladle or of the gas injection line.

Another purpose of the present invention is to provide an apparatus for refining liquid metal in which monitoring the stirring of the liquid metal gives indications for managing the pressure and flow rate of the inert gas to be blown through the porous plugs of the ladle.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, an apparatus according to the present invention for refining liquid metal comprises a ladle containing the liquid metal, provided with an open upper part and with at least one porous plug on a bottom wall thereof, a removable lid, a gas injection line connected to the at least one porous plug, and a control unit.

In accordance with one aspect of the present invention, the apparatus comprises a viewing unit mounted on the lid and comprising a support assembly with which there are associated at least one IR (infra-red) telecamera connected to the control unit in order to detect and transmit a sequence of thermographic images of a free surface of the liquid metal, at least one protection lens directly facing the open upper part, and an intermediate lens disposed between the at least one IR telecamera and the at least one protection lens.

By doing this, it is possible to detect a sequence of thermographic images continuously or at pre-established time intervals, even if the refining environment is thermally and chemically aggressive. In fact, thanks to the presence of the double lens, the IR telecamera always remains protected both from heat and also from splashes of slag and metal that could hit it.

In accordance with another aspect of the present invention, a viewing aperture is created on the support assembly which defines a direction of detection in which the at least one IR telecamera, the intermediate lens and, on each occasion or according to the circumstances, the at least one protection lens are aligned.

In accordance with another aspect of the present invention, the at least one protection lens can be selectively moved between an operating position, in correspondence with the viewing aperture, and at least one non-operating cleaning position, moved away from the viewing aperture. In this way, the at least one protection lens can be cleaned, and its transparency can be automatically restored before, after or during the ongoing process. Cleaning the protection lens allows to obtain quality thermographic images.

In accordance with another aspect of the present invention, the viewing unit comprises a selector member rotatably associated with the support assembly and on which the at least one protection lens is mounted peripherally. The rotation of the selector member advantageously allows to position the lens between the operating position and the at least one non-operating cleaning position automatically, on the basis of a program which depends on the refining process in progress or on specific input from an operator.

In accordance with another aspect of the present invention, at least one covering element can also be peripherally mounted on the selector member to cover the viewing aperture. Being able to have a covering element to selectively close the viewing aperture allows to prevent the most delicate components, such as the protection lens, the intermediate lens and the IR telecamera, from being exposed to a thermochemical and thermomechanical attack which, in some steps of the refining process, can be very aggressive.

In accordance with another aspect of the present invention, the support assembly comprises a pair of plates through which the viewing aperture is made, which are associated with each other and shaped in such a way as to define a hollow space, insulated from the outside, in which the selector member is housed. In this way, the selector member, which supports in rotation the at least one protection lens, and possibly also the at least one covering element, is protected from the ladle environment.

In accordance with another aspect of the present invention, the viewing unit comprises cleaning means disposed inside the hollow space and cooperating with the at least one protection lens when the at least one protection lens is in the at least one non-operating cleaning position. Advantageously, the cleaning means allow, if necessary, to restore the transparency of at least one measuring lens automatically, quickly and reliably, without needing to interrupt the process in progress or subsequent processes.

In accordance with another aspect of the present invention, the control unit contains instructions for the movement of the at least one protection lens according to one or more operating modes which depend on the refining process to be performed. Therefore, according to the steps of the process, at least one protection lens can remain in position for a certain interval of time, be cleaned or be alternated with the at least one covering element.

In accordance with another aspect of the present invention, the viewing unit advantageously comprises a plurality of distinct protection lenses. Having a certain number of protection lenses allows at least to increase the life of the individual protection lenses, which are used for a more limited time.

According to some embodiments of the present invention, the apparatus can be a ladle furnace provided with electrodes, in which the lid is disposed in cooperation with the upper aperture and is provided with corresponding through apertures to receive the electrodes.

According to some embodiments of the present invention, the apparatus can be a vacuum degasser comprising a vacuum chamber having a receptacle with an upper aperture, inside which the ladle is positioned, wherein the lid can be hermetically associated with the receptacle.

Some embodiments of the present invention concern a method for refining liquid metal comprising the following steps: preparing a ladle containing a liquid metal, provided with an open upper part and with at least one porous plug on a bottom wall thereof, temporarily positioning a removable lid, blowing, by means of a gas injection line, an inert gas inside the ladle through the liquid metal, by means of the at least one porous plug, controlling at least the gas injection line with a control unit.

In accordance with one aspect of the present invention, the method comprises monitoring a free surface of the liquid metal by means of a viewing unit mounted on the lid, wherein at least one IR telecamera connected to the control unit acquires and transmits a sequence of thermographic images of the free surface through at least one protection lens directly facing the open upper part, and an intermediate lens disposed between the at least one IR telecamera and the at least one protection lens.

In accordance with another aspect of the present invention, the method comprises alternatively positioning the at least one protection lens between an operating position, in correspondence with a viewing aperture defining a direction of detection in which the at least one IR telecamera and the intermediate lens are also aligned, and at least one non-operating cleaning position, moved away from the viewing aperture.

In accordance with another aspect of the present invention, the method comprises positioning a covering element in the operating position in place of the at least one protection lens.

In accordance with another aspect of the present invention, the method comprises positioning each protection lens of a plurality of protection lenses alternatively between the operating position and the non-operating cleaning position.

In accordance with another aspect of the present invention, monitoring the free surface of the liquid metal occurs continuously or discontinuously using a same protection lens. This is particularly advantageous because the analysis of the thermographic images will be more coherent, uniform and statistically consistent.

In accordance with a variant, monitoring the free surface of the liquid metal occurs discontinuously using different and distinct protection lenses. This mode of managing the protection lenses allows to increase the useful life of the protection lenses themselves, and can be used in the case of particularly aggressive environments.

In accordance with another aspect of the present invention, the control unit executes a recognition algorithm in order to identify, in each frame of the sequence of thermographic images, at least one exposed area in which the liquid metal is exposed with respect to a surface layer of slag, and a covered area in which the layer of slag completely covers the liquid metal.

In accordance with another aspect of the present invention, identifying the at least one exposed area and the covered area occurs by estimating a temperature order of the areas. Estimating the order of magnitude and not the punctual temperature allows to simplify the recognition algorithm and make the analysis much faster and more efficient.

In accordance with another aspect of the present invention, the control unit processes both geometric and also thermal information on the exposed area and on the covered area, and combines the information with pressure and flow rate values of the gas that passes through the at least one porous plug in order to determine a state of stirring of the liquid metal and an injection efficiency of the gas, as well as to adjust the gas feed flow rate.

In accordance with another aspect of the present invention, the control unit compares the geometric and/or thermal information on more than one exposed area and combines it with pressure and flow rate values of the gas that passes through corresponding porous plugs in order to determine an injection efficiency of the porous plugs.

In this way, it is possible to control the process continuously and instantly, but also to program a maintenance plan for the porous plugs, contributing to reducing production costs.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic view of an apparatus for refining liquid metal, according to the present invention;

FIG. 2 is a schematic view of another apparatus for refining liquid metal, according to the present invention;

FIGS. 3-5 are section views of the viewing unit present in the apparatus of FIGS. 1-2.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

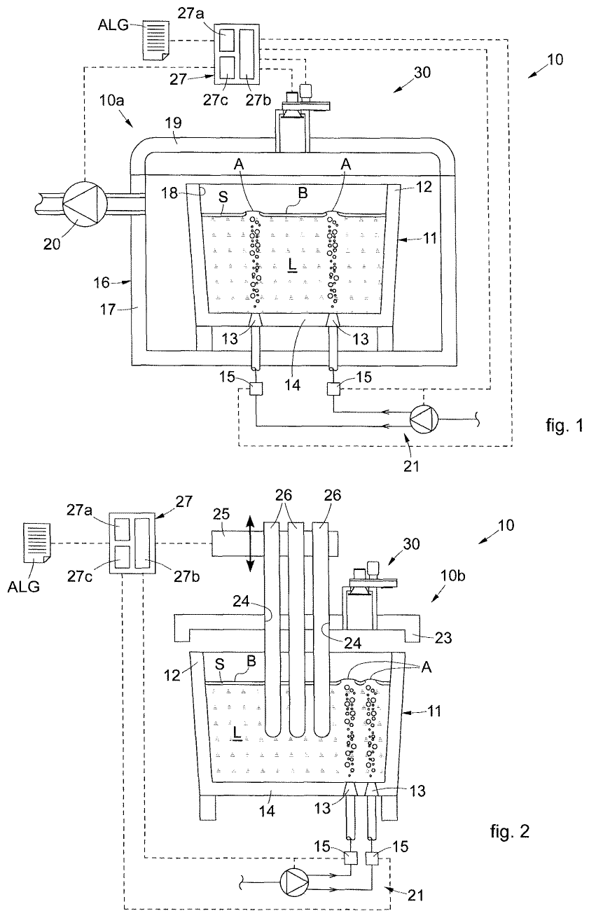

With reference to FIGS. 1 and 2, an apparatus 10, according to the present invention, for refining liquid metal L contained in a ladle 11 is normally used to facilitate the removal of inclusions and impurities from the liquid metal L while alloying elements are possibly inserted to obtain the desired chemical composition.

The ladle 11 is a bucket-shaped receptacle, lined internally with refractory material, intended to house the liquid metal L produced in a furnace, for example an electric arc furnace EAF, and to transport it downstream for the subsequent refining treatments in a ladle furnace 10b (FIG. 2) and possibly in a vacuum degasser 10a (FIG. 1), and finally toward continuous casting.

The ladle 11 is provided with an open upper part 12 and at least one porous plug 13 (usually two or three) passing through a bottom wall 14 of the ladle 11 and through which a gas, preferably inert, is blown able to determine a stirring of the liquid metal L contained.

The liquid metal L in the ladle 11 is covered by a layer of slag S which protects the metal bath during the refining processes until continuous casting, at the end of which the layer of slag S remains at the bottom of the ladle 11 and is subsequently removed.

The performance of the at least one porous plug 13 is monitored through sensors 15 capable of detecting a flow rate and/or pressure value of the gas flow which passes through the at least one porous plug 13.

The porous plug 13 has a structure such as to allow the passage of pressurized gas from the outside toward the inside of the ladle 11, but prevent the escape of liquid metal L.

A person of skill in the art will understand that as an alternative to the porous plug 13 there can be provided lances, nozzles, or other dispensing elements capable of blowing a gas inside the bath of liquid metal L to determine its stirring.

With reference to FIGS. 1 and 2, the ladle 11 preferably comprises two porous plugs 13 disposed in a decentralized position with respect to the center of the bottom wall 14. In this case, each porous plug 13 is favorably monitored by means of distinct and independent sensors 15.

According to other embodiments, the number of porous plugs 13 generally corresponds to two or three, but it can also be higher or lower.

The apparatus 10 can be a vacuum degasser 10a (FIG. 1) or a ladle furnace 10b (FIG. 2). Hereafter in the description, any elements common to both embodiments will be indicated with identical reference numbers.

With reference to FIG. 1, the vacuum degasser 10a is formed by a vacuum chamber 16 having a receptacle 17 with an upper aperture 18, inside which the ladle 11 is positioned, and a lid 19 that can be hermetically associated with the receptacle 17.

The vacuum degasser 10a comprises, or is connected to, a vacuum pump system 20, typically formed by mechanical pumps or steam ejectors.

The vacuum degasser 10a also comprises a gas injection line 21 configured to feed the at least one porous plug 13 with a preferably inert gas. In the case of two porous plugs 13, the gas injection line 21 could branch off into two independent segments along which the sensors 15 are disposed.

With reference to FIG. 2, the ladle furnace 10b comprises a lid 23 placed to cover the open upper part 12 of the ladle 11 and provided with one or more through apertures 24, a support structure 25 with electrodes 26 which can be moved through the through apertures 24 in order to be housed in the ladle 11, and its own gas injection line 21 having the characteristics described above.

The apparatus 10, whether it is a vacuum degasser 10a or a ladle furnace 10b, also comprises a control unit 27, configured to control the operation of the apparatus 10.

The control unit 27 is also operationally connected to the gas injection line 21 and to the sensors 15, to the vacuum pump system 20 (vacuum degasser 10a) and to the movement means of the support structure 25 (ladle furnace 10b). It is clear that apparatus 10 also comprises a whole series of additional sensors and instrumentation used to control the refining process which are not described and shown here.

The apparatus 10 also comprises an infrared viewing unit 30 associated with the lid 19, 23 operationally connected to the control unit 27.

The viewing unit 30 is installed on the top of the lid 19, 23. Preferably, the viewing unit 30 is installed in correspondence with a previously created or already provided structure or aperture, but which is not used, or is used for maintenance and/or inspection purposes, or created ad hoc.

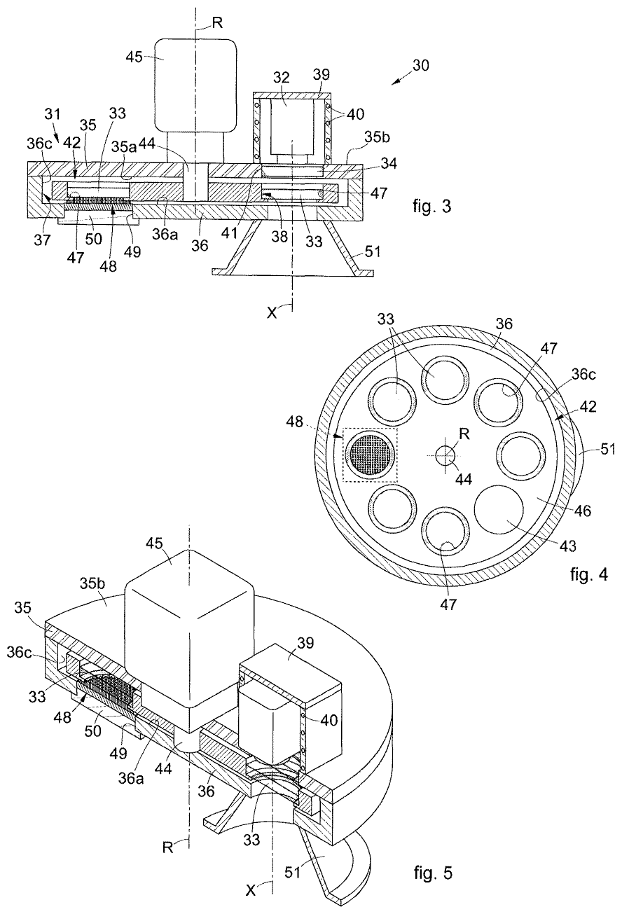

With reference to FIGS. 3-5, the viewing unit 30 comprises a support assembly 31 with which there are associated at least one IR telecamera 32 connected to the control unit 27 to detect and transmit a sequence of thermographic images of the free surface of the liquid metal L, at least one protection lens 33 which, during use, is directly facing the open upper part 12 of the ladle 11, in particular the free surface of the liquid metal L, and an intermediate lens 34 disposed between the IR telecamera 32 and the protection lens 33.

The at least one protection lens 33 and the intermediate lens 34 are characterized by a specific transparency index to allow the IR telecamera 32 to have the clearest possible view of the free surface of the liquid metal L.

By “free surface” of the liquid metal L we mean the surface of the bath of liquid metal L contained in the ladle 11, which can be defined by the surface layer of slag S and possibly by zones of liquid metal L which escapes from the layer of slag S due to the stirring generated by the blown gas.

The protection lens 33 and the intermediate lens 34 are preferably not part of the IR telecamera 32, that is, they are distinct and independent components both with respect to the IR telecamera 32 and also from each other.

The IR telecamera 32 is a thermal telecamera or infrared thermal imaging camera. According to one variant, an optical telecamera can also be provided in addition to the IR telecamera 32.

The support assembly 31 is formed by a pair of plates 35, 36 associated with each other and shaped in such a way as to define a hollow space 37 in which the at least one protection lens 33 is housed.

The plates 35 and 36 have an essentially circular plan shape. However, the person of skill in the art will understand that the shape of the plates 35, 36 is not limited to the circular one shown in FIGS. 3-5.

The pair of plates 35, 36 comprises a first plate, or upper plate, 35 and a second plate, or lower plate, 36, which during use faces the ladle 11, in particular the open upper part 12.

The hollow space 37 is defined by an internal lower surface 35a and an internal upper surface 36a of the upper plate 35 and of the lower plate 36, respectively, and laterally by an internal peripheral surface of one or the other plate 35, 36.

In the example of FIGS. 3-5, the internal peripheral surface is an internal peripheral surface 36c of the lower plate 36.

The upper plate 35 and the lower plate 36 are coupled to each other, preferably removably, by means of connection elements of a known type such as bolts, pins, tabs or others.

A viewing aperture 38 is created on the support assembly 31, passing through both plates 35, 36 along an axis or in a direction of detection X.

The direction of detection X is preferably orthogonal to the plates 35, 36, in particular to their upper and lower surfaces.

The viewing aperture 38 is preferably made in a peripheral zone of the plates 35, 36 with respect to a central point thereof.

An element 51 attached to the lower plate 36 can be associated with the viewing aperture 38. The element 51 has a substantially conical shape, preferably with the narrowest section located in correspondence with the viewing aperture 38.

The IR telecamera 32 is mounted on the upper plate 35 in correspondence with the viewing aperture 38. The IR telecamera 32 is mounted on the upper plate 35 in correspondence with an external upper surface 35b thereof, opposing the internal lower surface 35a.

Optionally, a connection flange, which is part of the support assembly 31, can be provided between the upper plate 35 and the IR telecamera 32.

The viewing unit 30 can comprise a shell 39 within which the IR telecamera 32 is disposed. The shell 39 can contain the IR telecamera 32 completely, and be removably connected to the upper plate 35, optionally by means of the connection flange.

The shell 39 can advantageously comprise cooling means 40, which can be defined by channels, tubes, coils or other similar elements, inside which a cooled fluid, for example water, air or air-mist, is made to flow.

The lens of the IR telecamera 32 can be provided with its own compressed air and/or inert gas cooling and cleaning system.

A seating 41 is created on a cross section of the viewing aperture 38 to house the intermediate lens 34.

The intermediate lens 34 can be held in position by a blocking ring and gasket, or other similar temporary retaining elements.

The seating 41 is preferably made in the upper plate 35. This allows to simplify operations of maintenance and possible replacement of the intermediate lens 34, because the upper plate 35 is more easily accessible than the lower plate 36. Alternatively, the seating 41 can be made in the lower plate 36.

The viewing unit 30 comprises a selector member 42 on which the at least one protection lens 33 is mounted peripherally. The selector member 42 is contained in the hollow space 37.

The at least one protection lens 33 is able to be selectively positioned between an operating position, in correspondence with the viewing aperture 38, and at least one non-operating position, moved away from the viewing aperture 38. Such non-operating position can be a cleaning or parking non-operating position.

According to some embodiments, a plurality of protection lenses 33 are peripherally mounted on the selector member 42, specifically N distinct protection lenses 33. The number N of protection lenses 33 can be comprised between 1 and 20, for example 12.

In this case, one of the protection lenses 33 can be positioned in the operating position while the other protection lenses 33 are in the at least one cleaning or parking non-operating position.

According to possible embodiments, at least one covering element 43 can also be peripherally mounted on the selector member 42 to selectively cover the viewing aperture 38. The covering element 43 can be a lens, a disc, a plate, made of metal material, for example steel. Alternatively, the covering element 43 can also be defined by a solid part of the selector disk 46.

The covering element 43 is configured, when disposed in the operating position, to protect the intermediate lens 34 by acting as a physical barrier in the most critical steps of the refining process. More in particular, the covering element 43 allows to protect the intermediate lens 34 and the IR telecamera 32 from the combined action of the splashes of slag and liquid metal L which, in some steps of the refining process, generate a very aggressive thermochemical and thermomechanical attack.

The selector member 42 is rotatably associated with the support assembly 31 by means of a drive shaft 44, passing through the upper plate 35 and operatively connected to a drive member 45. In other words, the selector member 42 is a rotating carousel on which the protection lenses 33 and the at least one covering element 43 are mounted.

The drive shaft 44 has an axis of rotation R substantially parallel to the axis of detection X.

The drive member 45 is part of the viewing unit 30 and is preferably attached to the upper plate 35.

The drive member 45 is connected to the control unit 27 in order to transmit, for example by means of an encoder, an angular position of the selector member 42 and to receive a command signal to move the selector member 42 in rotation.

The selector member 42 comprises a selector disc 46 provided, on a circumference thereof, with at least one housing 47, passing through the body of the selector disc 46 and conformed to house the at least one protection lens 33.

The selector member 42 can also comprise at least one additional housing 47 designated to house the at least one covering element 43.

With reference to FIG. 4, the selector disc 46 is provided with a plurality of housings 47 to each support and contain a distinct protection lens 33.

The number of housings 47 provided on the selector disc 46 can advantageously be equal to the sum of the number of protection lenses 33 and the number of covering elements 43.

According to a possible embodiment, the housings 47 can be disposed one in succession to the other according to a circular configuration.

The housings 47 can be equally spaced apart angularly, or they can be created at non-uniform angular distances.

According to a possible variant, the protection lens 33 can be single and have an annular shape, defined by two concentric circles with a different radius, to form a transparent protection strip. Alternatively, a plurality of protection lenses 33, for example with a round shape, can be incorporated into a single annular-shaped component. The housing 47 will have a mating annular shape.

The selector disc 46 is keyed onto the drive shaft 44 and made to rotate around the axis of rotation R in such a way as to position the at least one protection lens 33 in the operating position, that is, in correspondence with the viewing aperture 38. The protection lens 33 is therefore aligned with both the intermediate lens 34 and also the IR telecamera 32 in the direction of detection X, and faces the open upper part 12 of the ladle 11 through the viewing aperture 38.

In the case of a plurality of protection lenses 33, each one of them can be taken into the operating position at a time. The other protection lenses 33 are correspondingly in a non-operating position inside the hollow space 37, insulated with respect to the ladle environment by means of the lower plate 36 which acts as a protective barrier.

The selector disc 46 can also be made to rotate in order to position the at least one covering element 43 in an operating position to cover the viewing aperture 38.

The viewing unit 30 comprises cleaning means 48 disposed inside the hollow space 37 and cooperating with the at least one protection lens 33 when the at least one protection lens 33 is in the at least one non-operating cleaning position.

The cleaning means 48 are facing toward the at least one protection lens 33 in order to mechanically remove the metal particles and slag possibly deposited on the surface of the at least one protection lens 33, restoring its at least partial transparency.

When the viewing unit 30 comprises a plurality of distinct protection lenses 33, the cleaning means 48 are alternately interfering with each of the protection lenses 33 during their movement into the non-operating cleaning position.

The cleaning means 48 are associated with the lower plate 36 in a position different from that in which the viewing aperture 38 is created. In a possible embodiment, the cleaning means 48 can be in a position diametrically opposing that of the viewing aperture 38.

An installation aperture 49 is made through in the lower plate 36 to position the cleaning means 48, which are attached to a support plate 50, FIGS. 3 and 5.

The support plate 50 is removably secured to the lower plate 36 by means of connection elements of a known type such as bolts, pins, tabs, grippers, clamps or others.

According to other embodiments, the cleaning means 48 can be attached directly to the internal upper surface 36a of the lower plate 36.

The cleaning means 48 are essentially formed by a brush element consisting of a support to which metal wires are attached. The relative movement between the at least one protection lens 33 and the metal wires allows to determine a rubbing action that cleans the at least one protection lens 33.

According to a variant, the cleaning means 48 can also or only comprise spraying elements configured to dispense a fluid, liquid, gaseous or two-phase, under pressure against the at least one protection lens 33.

The cleaning of the at least one protection lens 33 can be achieved by making a certain number of revolutions with the selector disc 46, clockwise and/or counterclockwise around the axis of rotation R.

The cleaning can be performed on a single protection lens 33 or on all protection lenses 33. The number of revolutions to clean all the protection lenses 33, or each individual protection lens 33, is a controllable parameter managed by the control unit 27 on the basis of the refining process in progress or specific input from an operator.

The positioning of the at least one protection lens 33 occurs according to one or more operating logics that can depend on the specific application, that is, whether it is the vacuum degasser 10a or the ladle furnace 10b, or on the specific step of the refining process that is taking place in the vacuum degasser 10a or in the ladle furnace 10b.

These operating logics can be stored in the control unit 27.

In accordance with a first operating mode, during the refining process that occurs on a same ladle 11, the same protection lens 33 is used. This protection lens 33 can remain in the operating position during all the steps of the refining process (continuous detection) or it can be cleaned cyclically and returned to the operating position (interval detection). This first operating mode is advantageous because it is possible to obtain a uniform detection of the sequence of thermographic images of the free surface of the liquid metal L. In fact, using the same protection lens 33 allows to not introduce “noise” in the analysis of the sequence of thermographic images, as will be explained in more detail below.

In accordance with a second operating mode, in which the viewing unit 30 comprises a plurality of distinct protection lenses 33, during the refining process that occurs on a same ladle 11, each protection lens 33 is taken sequentially into the operating position. In this case, at least two protection lenses 33 are used alternating between the operating position and the non-operating position, which can be a parking or cleaning position.

Any complete or partial cleaning cycles can be provided before, after or even during one or more steps of the refining process.

With reference to FIGS. 1-2, the viewing unit 30 is installed on the lid 19, 23 in such a position that the IR telecamera 32 is able to frame at least the zone of the free surface of the liquid metal L which is above a corresponding zone of the bottom wall 14 of the ladle 11 where the at least one porous plug 13 is present.

Advantageously, the IR telecamera 32 is able to frame the entire free surface of the liquid metal L.

The IR telecamera 32 is capable of detecting and measuring at least one temperature value of at least one dot, a set of dots, a zone comprised in each frame of the sequence of thermographic images. By “dot” we mean a single pixel of an image of the sequence of images.

The correct detection of the sequence of thermographic images by the IR telecamera 32 is possible firstly thanks to the presence of the double lens, protection 33 and intermediate 34, and secondly thanks to the presence of the selector member 42 which allows to keep the at least one protection lens 33 efficient by moving it according to the operating modes described above or according to other operating modes provided for the specific refining process.

The control unit 27 comprises an internal storage module 27a, a processor 27b and a communication module 27c. In an alternative variant, the control unit 27 can be connected to one or more external databases.

A recognition algorithm ALG is installed in the storage module 27a which, when executed by the processor 27b, is able to identify in each frame of the sequence of thermographic images an exposed area A, known to the people of skill in the art by the term “open-eye”, in which the liquid metal L is exposed with respect to the layer of slag S, and a covered area B, in which the layer of slag S completely covers the underlying liquid metal L.

The exposed area A can be detected because it emits a different radiation from the covered area B. For example, the radiation can be different because of a different temperature and same emissivity, same temperature but different emissivity, different temperature and emissivity.

In the case of two porous plugs 13, two distinct exposed areas A can be visible. In some cases, the two distinct exposed areas A can intersect and join in a single larger area, but with contours which are in any case defined by and traceable to one or the other of the porous plugs 13.

The exposed area A is a thermal hot-spot area. The covered area B is a thermal cold-spot area. For example, the exposed area A can be characterized by a temperature in the range of about 1500 °C, while the covered area B can be characterized by a temperature in the range of about 1000-1100 °C.

The recognition algorithm ALG is at least able to distinguish the exposed area A from the covered area B by estimating a temperature order of the areas A, B. In fact, for the application of the present invention, it is not necessary to obtain a precise value, but it is sufficient to know that the exposed area A has a higher temperature, by about 600-800 °C, compared to the covered area B.

The exposed area A that can form at the upper part, substantially in correspondence with each of the porous plugs 13 provided in the ladle 11, is determined by the flow of blown gas which, if fed with higher (lower) pressure and/or flow rate should determine a correspondingly larger (smaller) exposed area A.

The sequence of thermographic images detected by the IR telecamera 32 is transmitted to the control unit 27 and processed in order to generate both geometric information, for example a surface size of the at least one exposed area A and of the covered area B, as well as thermal information, for example a temperature and/or an emissivity of the exposed area A and of the covered area B.

The surface size of the at least one exposed area A, as well as its temperature, are directly correlated to the pressure and/or injection flow rate of the inert gas through the at least one porous plug 13.

The measured values of the injection pressure and flow rate of the inert gas can be stored in a database contained in the storage module 27a.

The control unit 27 is able to combine the information obtained by processing the sequence of thermographic images detected by the IR telecamera 32 with the aforementioned pressure and flow rate values, in order to determine the state of stirring of the liquid metal in the ladle 11 and the efficiency of the gas injection.

The control unit 27 is also able to use historicized flow rate and pressure values relating to previous processes, combined with the thermographic measurements performed.

The information generated by the control unit 27 is translated into corresponding control signals transmitted to the components of the apparatus 10 by means of the communication module 27c to control the ongoing process. These components can be one or more of either the vacuum pump system 20, the gas injection line 21, the electrodes 26 and other components of the apparatus 10 not described or shown.

The control signals can comprise a control signal for controlling, for example, the position of the electrodes 26, the power of the electrodes 26 (ladle furnace 10b) or the pressure/depression of the vacuum chamber 16 (vacuum degasser 10a), the pressure and flow rate of the injection of gas through the at least one porous plug 13 (ladle furnace 10b and vacuum degasser 10a).

In this way, it is possible to control the stirring of the liquid metal L contained in the ladle 11 and instantly evaluate the operating state of the at least one porous plug 13. This allows to optimize the stirring of the liquid metal L in an automated manner and to control the operation of the at least one porous plug 13 on the basis of a current condition thereof. Moreover, it is possible to program a predictive maintenance plan of the one or more porous plugs 13, contributing to the reduction of production costs.

It is clear that modifications and/or additions of parts may be made to the apparatus 10 and to the method as described heretofore, without departing from the field and scope of the present invention, as defined by the claims.

It is also clear that, although the present invention has been described with reference to some specific examples, a person of skill in the art will be able to achieve other equivalent forms of an apparatus and method for refining liquid metal, having the characteristics as set forth in the claims and hence all coming within the field of protection defined thereby.

In the following claims, the sole purpose of the references in brackets is to facilitate their reading and they must not be considered as restrictive factors of the field of protection defined by the claims.

1. Apparatus for refining liquid metal comprising: a ladle containing the liquid metal provided with an open upper part and with at least one porous plug on a bottom wall thereof, a removable lid, a gas injection line connected to said at least one porous plug, and a control unit, wherein it comprises a viewing unit mounted on said lid and comprising a support assembly with which there are associated at least one IR telecamera connected to said control unit to detect and transmit a sequence of thermographic images of a free surface of said liquid metal, at least one protection lens directly facing said open upper part, and an intermediate lens disposed between said at least one IR telecamera and said at least one protection lens.

2. Apparatus as in claim 1, wherein a viewing aperture is created on said support assembly which defines a direction of detection in which said at least one IR telecamera, said intermediate lens and, on each occasion, said at least one protection lens are aligned.

3. Apparatus as in claim 2, wherein said at least one protection lens is selectively movable between an operating position, in correspondence with said viewing aperture, and at least one non-operating cleaning position, moved away from said viewing aperture.

4. Apparatus as in claim 1, wherein said viewing unit comprises a selector member rotatably associated with said support assembly and on which said at least one protection lens is mounted peripherally.

5. Apparatus as in claim 4, wherein at least one covering element is also peripherally mounted on said selector member to cover said viewing aperture.

6. Apparatus as in claim 4, wherein said support assembly comprises a pair of plates through which said viewing aperture is made, which are associated with each other and shaped in such a way as to define a hollow space, insulated from the outside, in which said selector member is housed.

7. Apparatus as in claim 6, wherein said viewing unit comprises cleaning means disposed inside said hollow space and cooperating with said at least one protection lens when said at least one protection lens is in said at least one non-operating cleaning position.

8. Apparatus as in claim 1, wherein said control unit contains instructions for the movement of said at least one protection lens according to one or more operating modes which depend on the refining process to be performed.

9. Apparatus as in claim 1, wherein said viewing unit comprises a plurality of distinct protection lenses.

10. Apparatus as in claim 1, wherein it is a ladle furnace provided with electrodes, in which said lid is disposed in cooperation with said upper aperture and is provided with corresponding through apertures for said electrodes.

11. Apparatus as in claim 1, wherein it is a vacuum degasser comprising a vacuum chamber having a receptacle with an upper aperture, inside which said ladle is positioned, wherein said lid can be hermetically associated with said receptacle.

12. Method for refining liquid metal comprising the following steps:
preparing a ladle containing a liquid metal, provided with an open upper part and with at least one porous plug on a bottom wall thereof,
temporarily positioning a removable lid over said open upper part,
blowing, by means of a gas injection line, an inert gas inside said ladle through said liquid metal, by means of said at least one porous plug,
controlling at least said gas injection line with a control unit,
characterized in that it comprises monitoring a free surface of said liquid metal by means of a viewing unit mounted on said lid, wherein at least one IR telecamera connected to said control unit detects and transmits a sequence of thermographic images of said free surface acquired through at least one protection lens directly facing said open upper part, and an intermediate lens disposed between said at least one IR telecamera and said at least one protection lens.

13. Method as in claim 12, wherein it comprises alternatively positioning said at least one protection lens between an operating position, in correspondence with a viewing aperture defining a direction of detection in which said at least one IR telecamera and said intermediate lens are also aligned, and at least one non-operating cleaning position, moved away from said viewing aperture.

14. Method as in claim 13, wherein that it comprises positioning a covering element in the operating position in place of said at least one protection lens.

15. Method as in claim 13, wherein it comprises positioning each protection lens of a plurality of protection lenses alternatively between said operating position and said non-operating cleaning position.

16. Method as in claim 12, wherein monitoring said free surface of said liquid metal occurs continuously or discontinuously using a same protection lens.

17. Method as in claim 12, wherein monitoring said free surface of said liquid metal occurs discontinuously using different and distinct protection lenses.

18. Method as in claim 12, wherein said control unit executes a recognition algorithm in order to identify, in each frame of said sequence of thermographic images, at least one exposed area in which said liquid metal is exposed with respect to a surface layer of slag, and a covered area in which said layer of slag completely covers said liquid metal.

19. Method as in claim 18, wherein identifying said at least one exposed area and said covered area occurs by estimating a temperature order of said areas.

20. Method as in claim 18, wherein said control unit processes both geometric and also thermal information on said exposed area and on said covered area, and combines said information with pressure and flow rate values of the gas that passes through said at least one porous plug in order to determine a state of stirring of said liquid metal and an injection efficiency of the gas, as well as to adjust the gas feed flow rate.

21. Method as in claim 12, wherein said control unit compares the geometric and/or thermal information on more than one exposed area and combines them with pressure and flow rate values of the gas that passes through corresponding porous plugs in order to determine an injection efficiency of said porous plugs.
